(19) United States
(12) Patent Application Publication
(10) Pub. No.: US 2022/0339612 A1
(43) Pub. Date: Oct. 27, 2022

(54) LOW-TEMPERATURE SYNTHESIS OF CATALYST BASED ON ZEOLITE AFX AND APPLICATION THEREOF IN NH3-SCR

(71) Applicant: IFP Energies nouvelles, Rueil-Malmaison (FR)

(72) Inventors: Bogdan HARBUZARU, RUEIL-MALMAISON CEDEX (FR); David BERTHOUT, RUEIL-MALMAISON CEDEX (FR); Eric LLIDO, RUEIL-MALMAISON CEDEX (FR); Laetitia JOTHIE, RUEIL-MALMAISON CEDEX (FR)

(21) Appl. No.: 17/764,264

(22) PCT Filed: Sep. 18, 2020
(86) PCT No.: PCT/EP2020/076093

§ 371 Date: Mar. 28, 2022

(30) Foreign Application Priority Data
Sep. 30, 2019 (FR) FR1910842

(51) Int. Cl. B01J 29/70; F01N 3/20; B01J 37/04; B01J 37/08; B01J 37/02

(52) U.S. Cl. CPC B01J 29/7003; F01N 3/2066; B01J 37/04; B01J 37/08; B01J 37/0215; F01N 2570/14

(57) ABSTRACT

The invention relates to a process for preparing a catalyst based on an AFX zeolite exchanged with at least one transition metal, comprising at least the following steps:

i) mixing, in an aqueous medium, of at least one source of silicon (Si) in SiO₂ oxide form, at least one source of aluminum (Al) in Al₂O₃ oxide form, 1,6-bis(methylpiperidinium)hexane dihydroxide, and at least one source of at least one alkali metal, until a homogeneous precursor gel is obtained;
ii) hydrothermal treatment at a temperature between 75° C. and 95° C., limits included;
iii) at least one ion exchange with a solution comprising at least one species capable of releasing a transition metal,
iv) heat treatment by drying followed by at least one calcination under a stream of air at a temperature between 400 and 700° C. The invention also relates to the catalyst obtained and to the use thereof for the selective reduction of NOx.

### TECHNICAL FIELD

A subject of the invention is a process for preparing a catalyst based on an AFX-structure zeolite synthesized at low temperature and on at least one transition metal, the catalyst prepared or capable of being prepared by the process, and the use thereof for the selective catalytic reduction of NOx in the presence of a reducing agent, in particular on internal combustion engines.

### PRIOR ART

Emissions of nitrogen oxides (NOx) resulting from the combustion of fossil fuels are a serious concern for society. Increasingly stringent standards have been put in place by government authorities in order to limit the impact of combustion emissions on the environment and on health. For light vehicles in Europe, under the Euro 6c standard, emissions of NOx and of particles must not exceed a very low level in all operating conditions. The new WLTC test cycle (Worldwide Harmonized Light Vehicles Test Cycle) and the Real Driving Emissions (RDE) regulation combined with compliance factors require the development of a highly effective pollution control system in order to meet these targets. Selective catalytic reduction (SCR) has emerged as an effective technology for removing nitrogen oxides from the oxygen-rich exhaust gases that are typical of diesel and spark-ignition engines in lean-mixture mode. Selective catalytic reduction is carried out using a reducing agent, generally ammonia, and can therefore be referred to as NH₃-SCR. The ammonia (NH₃) involved in the SCR process is usually generated via the decomposition of an aqueous urea solution (AdBlue or DEF) and produces N₂ and H₂O when reacted with NOx.

Zeolites exchanged with transition metals are used notably as catalysts for NH₃—SCR applications in transport. Small-pore zeolites, particularly copper-exchanged chabazites, are particularly suitable. They exist commercially in the form of silicoaluminophosphate Cu-SAPO-34 and aluminosilicates Cu—SSZ-13 (or Cu—SSZ-62). Their hydrothermal resistance and NOx conversion efficiency make them the current standards. However, as the standards become increasingly restrictive, there is a need to further improve the performance of the catalysts.

The use of AFX-structure zeolites for NH₃—SCR applications is known, but few studies evaluate the efficiency of catalysts that use this zeolite.

Fickel et al, (Fickel, D. W., & Lobo, R. F., The Journal of Physical Chemistry C, 2010, 114(3), 1633-1640) studies the use of a copper-exchanged SSZ-16 (with AFX structure) for NOx removal. This zeolite is synthesized in accordance with U.S. Pat. No. 5,194,235 (synthesis at 150° C. for 6 hours), in which copper is introduced by exchange using copper(II) sulfate at 80° C. for 1 hour. Recent results (Fickel, D. W., D'Addio, E., Lauterbach, J. A., & Lobo, R. F., Applied Catalysis B: Environmental, 2011, 102(3), 441-448) show excellent conversion and good hydrothermal resistance for a load containing 3.78% by weight of copper.

AFX-structure zeolites comprise in particular the zeolite SSZ-16 and the zeotypes SAPO-56 and MEAPSO-56. The AFX-structure zeolite has a three-dimensional system of pores delimited by eight tetrahedrons and is formed by two types of cages: gmelinite (GME cage) and a large AFT cage (˜8.3×13.0 Å). Numerous methods for synthesizing AFX-structure zeolites, and in particular the zeolite SSZ-16, are known. The SSZ-16 zeolite was synthesized using nitrogenous organic species derived from 1,4-di(1-azoniabicyclo[2.2.2]octane)butyl dibromide type and with a crystallization time typically greater than 3 days and at a temperature greater than or equal to 140° C. (U.S. Pat. No. 4,508,837). Chevron Research and Technology Company prepared the SSZ-16 zeolite in the presence of DABCO-Cₙ-diquat cations, where DABCO represents 1,4-diazabicyclo[2,2,2]octane and n is 3, 4 or 5 with a crystallization time typically greater than 3 days and at a temperature greater than 100° C., preferably greater than 130° C. (U.S. Pat. No. 5,194,235). S. B. Hong et al. used the diquaternary alkylammonium ion Et6-diquat-n, where Et6-diquat represents N′,N′-bis-triethylpentanediammonium and n is 5, as a structuring agent for the synthesis of the SSZ-16 zeolite with a formation time of the SSZ-16 zeolite of between 7 and 14 days and at a temperature of 160° C. (Micropor. Mesopor. Mat., 60 (2003) 237-249). Mention may also be made of the use of 1,3-bis(adamantyl)imidazolium cations as a structuring agent for the preparation of AFX-structure zeolite with a crystallization time of between 7 and 10 days and generally of between 2 and 15 days, and at a temperature greater than 100° C., preferably between 120 and 160° C. (R. H. Archer et at, Microp. Mesopor. Mat., 130 (2010) 255-265, Johnson Matthey Company WO2016077667A1), Inagaki Satoshi et at (JP2016169139A) used divalent N,N,N′,N′-tetraarquirubicyclo[2.2.2]oct-7-ene-2,3:05,6-dipyrrolidium cations substituted with alkyl groups with a crystallization time generally of between 20 and 400 hours and at temperatures between 100 and 200° C., preferably between 150 and 175° C., to prepare the SSZ-16 zeolite. Chevron U.S.A. (WO2017/200607 A1) proposes to carry out the synthesis of an SSZ-16 zeolite with a crystallization time of from 1 to 28 days and at temperatures between 130 and 175° C. using the dications: 1,1′-(1,4-cyclohexylenedimethylene)bis[1-methylpiperidinium], 1,1′-(1,4-cyclohexylenedimethylene)bis[1-methylpyrrolidinium], 1,1′-(1,4-cyclohexylenedimethylene)bis[1-ethylpyrrolidinium]. H.-Y. Chen et at (Johnson Matthey Company, US2018/0093897) used a mixture of cations containing at least 1,3-bis(adamantyl)imidazolium and a neutral amine to prepare the AFX-structure JMZ-10 zeolite in the absence of alkali metal cations with a crystallization time between 1 and 20 days and at temperatures between 100 and 200° C. H-Y. Chen et al. (Johnson Matthey Company, US2018/0093259) used a mixture of cations containing an organic molecule chosen from 1,3-bis(adamantyl)imidazolium, N,N-dimethyl-3,5-dimethylpiperidinium, N,N-diethyl-cis-2,6-dimethylpiperidinium, N,N,N-1-trimethyladamantylammonium, N,N,N-dimethylethylcyclohexylammonium and at least one alkaline-earth metal cation to obtain the AFX-structure JIM-7 zeolite which has Al sites that are close compared to a zeolite obtained by a synthesis using alkali metal cations. The time required to obtain this zeolite ranges from 3 to 15 days at a temperature greater than 100° C., preferably between 120 and 180° C.

K. G. Strohmaier et al, (Exxon Mobil, WO2017202495A1) used the organic molecule 1,1′-(hexane-1,6-diyl)bis(1-methylpiperidinium) in the presence of a metal complex stabilized by amine ligands to obtain an AFX-structure zeolite with a crystallization time of 1 day to approximately 100 days and at temperatures between 100 and 200° C., preferably between 150 and 170° C.

The applicant has discovered that a catalyst based on an AFX-structure zeolite prepared according to a particular synthesis method, that is to say at crystallization temperatures less than or equal to 95° C., and at least one transition metal, in particular copper, exhibits advantageous results in terms of NO conversion and selectivity toward N₂O. The NOx conversion performance, especially at low temperature (T<250° C.), is, notably, better than that obtained with prior art catalysts, such as catalysts based on a copper-exchanged AFX-structure zeolite, while still retaining good selectivity toward nitrous oxide N₂O. Another advantage of this zeolite synthesis method is that it is not necessary to use reactors which operate at a pressure above atmospheric pressure.

### SUMMARY OF THE INVENTION

The invention relates to a process for preparing a catalyst based on an AFX zeolite exchanged with at least one transition metal, comprising at least the following steps:

i) mixing, in an aqueous medium, of at least one source of silicon (Si) in SiO₂ oxide form, at least one source of aluminum (Al) in Al₂O₃ oxide form, a nitrogenous organic compound R, R being 1,6-bis(methylpiperidinium)hexane dihydroxide, and at least one source of at least one alkali metal chosen from lithium, potassium or sodium, and the mixture of at least two of these metals, the reaction mixture having the following molar composition;

SiO₂/Al₂O₃ between 4 and 60, preferably between 8 and 40,

H₂O/SiO₂ between 5 and 60, preferably between 10 and 40,

R/SiO₂ between 0.05 and 0.50, preferably between 0.10 and 0.30,

M₂O/SiO₂ between 0.10 and 0.30, preferably between 0.15 and 0.25, until a homogeneous precursor gel is obtained;

ii) hydrothermal treatment of said precursor gel obtained at the end of step i) at a temperature between 75° C. and 95° C.; limits included, for a period of between 40 and 100 hours, limits included, to obtain a solid crystalline phase, termed “solid”;

iii) at least one ion exchange comprising bringing said solid obtained at the end of the previous step into contact with a solution comprising at least one species that is capable of releasing a transition metal, in solution in reactive form, with stirring at ambient temperature for a period of between 1 hour and 2 days:

iv) heat treatment by drying the solid obtained at the end of the previous step at a temperature between 20 and 150° C., followed by at least one calcination under a stream of air at a temperature between 400 and 700° C.

Steps iii) and iv) may be reversed, and optionally repeated.

The precursor gel obtained at the end of step i) advantageously has a molar ratio of the total amount, expressed as oxides, of tetravalent elements to the total amount, expressed as oxides, of trivalent elements of between 4.00 and 60.00, preferably between 8.00 and 40.00, limits included.

It is possible to add seed crystals of an AFX-structure zeolite to the reaction mixture of step i), preferably in an amount of between 0.05% and 10% of the total mass of the sources of alumina and of silica in anhydrous form, used in the reaction mixture, said seed crystals not being taken into account in the total mass of the sources of alumina and of silica.

Step i) can comprise a step of maturing the reaction mixture at a temperature between 20 and 60° C., with or without stirring, for a period of time. The hydrothermal treatment of step ii) can be carried out at atmospheric pressure, preferably at a temperature between 85 and 95° C., limits included, fora period preferably between 40 and 80 hours, very preferably between 48 and 80 hours, limits included.

The ion-exchange step iii) may be performed by bringing the solid into contact with a solution comprising just one species capable of releasing a transition metal or by bringing the solid into contact successively with various solutions, each comprising at least one, preferably just one, species capable of releasing a transition metal, the transition metals of the various solutions preferably being different from one another.

Said at least one transition metal released in the exchange solution of step iii) may be selected from the group made up of the following elements: Ti, V, Mn, Mo, Fe, Co, Cu, Cr, Zn, Nb, Ce, Zr, Rh, Pd, Pt, Au, W, Ag, preferably from the group made up of the following elements: Fe, Cu, Nb, Ce or Mn, more preferably from Fe or Cu, and even more preferably said transition metal is Cu.

The content of transition metal(s) introduced by the ion-exchange step iii) is advantageously between 0.5 and 6% by mass, preferably between 0.5 and 5% by mass, more preferably between 1 and 4% by mass, relative to the total mass of the final anhydrous catalyst.

Step iv) of heat treatment can comprise drying of the solid at a temperature between 20 and 150° C., preferably of between 60 and 100° C., for a period of between 2 and 24 hours, followed by at least one calcination under air, which is optionally dry, at a temperature between 450 and 700° C., preferably of between 500 and 600° C., for a period of between 2 and 20 hours, preferably of between 5 and 10 hours, even more preferably of between 6 and 9 hours, the flow rate of optionally dry air being preferably between 0.5 and 1.5 L/h/g of solid to be treated, even more preferably between 0.7 and 1.2 L/h/g of solid to be treated.

The invention also relates to a catalyst based an AFX zeolite and on at least one transition metal obtained by the process according to any one of the variants described.

The transition metal(s) may be selected from the group formed by the following elements: Ti, V, Mn, Mo, Fe, Co, Cu, Cr, Zn, Nb, Ce, Zr, Rh, Pd, Pt, Au, W, Ag, preferably from the group made up of the following elements: Fe, Cu, Nb, Ce or Mn, more preferably from Fe or Cu, and even more preferably said transition metal is Cu.

The total content of transition metals is advantageously between 0.5 and 6% by mass, preferably between 0.5 and 5% by mass, more preferably between 1 and 4% by mass, relative to the total mass of the final anhydrous catalyst.

In one embodiment, the catalyst comprises copper, alone, at a content of between 0.5% and 6% by weight, preferably between 0.5% and 5% by weight, very preferably between 1% and 4% by weight, relative to the total mass of the anhydrous final catalyst.

In another embodiment, the catalyst comprises copper in combination with at least one other transition metal chosen from the group made up of Fe, Nb, Ce, Mn, the content of copper in the catalyst being between 0.05% and 2% by mass, preferably between 0.5% and 2% by mass, the content of said at least one other transition metal being between 1% and 4% by mass, relative to the total mass of the anhydrous final catalyst.

In yet another embodiment, the catalyst comprises iron in combination with another metal chosen from the group made up of Cu, Nb, Ce, Mn, the iron content being between 0.05% and 2% by mass, preferably between 0.5% and 2% by mass, the content of said other transition metal being between 1% and 4% by mass, relative to the total mass of the anhydrous final catalyst.

The invention also relates to the use of the catalyst as described above in any one of its variants or obtained by the process according to any one of its variants, for the selective reduction of NO by a reducing agent such as NH₃ or H₂.

The catalyst may be formed by deposition in the form of a coating on a honeycomb structure or a plate structure.

The honeycomb structure may be formed by parallel channels which are open at both ends or may comprise porous filtering walls in the case of which the adjacent parallel channels are alternately blocked at either side of the channels.

The amount of catalyst deposited on said structure may be between 50 and 180 g/L for the filtering structures and between 80 and 200 g/L for the structures with open channels.

The catalyst may be combined with a binder such as ceria, zirconium oxide, alumina, non-zeolitic silica-alumina, titanium oxide, a cerin-zirconia mixed oxide, a tungsten oxide and/or a spinel in order to be formed by deposition in the form of a coating.

Said coating may be combined with another coating having capacities for adsorbing pollutants, in particular NOx, for reducing pollutants, in particular NOx, or promoting the oxidation of pollutants.

Said catalyst may also be in the form of an extrudate, containing up to 100% of said catalyst.

Advantageously, the structure coated with said catalyst or obtained by extrusion of said catalyst is integrated into an exhaust line of an internal combustion engine.

### LIST OF FIGURES

FIG. 1 represents the chemical formula of the nitrogenous organic compound which may be chosen as structuring agent used in the synthesis process according to the invention.

FIG. 2 represents the X-ray diffraction pattern of the AFX zeolite obtained according to Example 2.

Other characteristics and advantages of the process for preparing the catalyst according to the invention will become apparent on reading the following description of non-limiting exemplary embodiments with reference to the appended figures described below.

### DESCRIPTION OF THE EMBODIMENTS

The invention relates to a process for preparing a catalyst based on an AFX-structure zeolite and at least one transition metal, comprising at least the following steps:

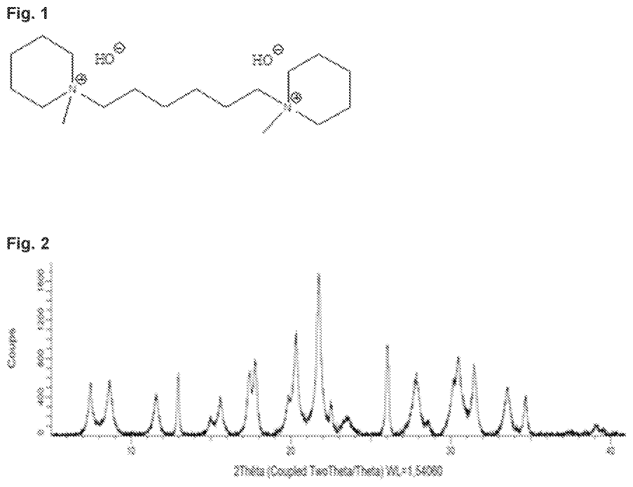

i) mixing, in an aqueous medium, of at least one source of silicon (Si) in SiO₂ oxide form, at least one source of aluminum (Al) in Al₂O₃ oxide form, a nitrogenous organic compound R, R being 1,6-bis(methylpiperidinium)hexane dihydroxide (FIG. 1), and at least one source of at least one alkali metal chosen from lithium, potassium or sodium, and the mixture of at least two of these metals, the reaction mixture having the following molar composition:

SiO₂/Al₂O₃ between 4 and 60, preferably between 8 and 40,

H₂O/SiO₂ between 5 and 60, preferably between 10 and 40

R/SiO₂ between 0.05 and 0.50, preferably between 0.10 and 0.30

M₂O/SiO₂ between 0.10 and 0.30, preferably between 0.15 and 0.25, until a homogeneous precursor gel is obtained;

ii) hydrothermal treatment of said precursor gel obtained at the end of step i) at a temperature between 75 and 95° C., preferably between 85° C. and 95° C., limits included, for a period of between 40 and 100 hours.

The SiO₂/Al₂O₃ ratio of the AFX zeolite obtained is advantageously between 4 and 60, preferably between 8 and 40, limits included.

Preferably, M is sodium.

Preferably, the source of at least one alkali metal is sodium hydroxide.

Seed crystals of an AFX-structure zeolite can be added to the reaction mixture of step i), preferably in an amount between 0.05% and 10% of the total mass of SiO₂ and Al₂O₃, said seed crystals not being taken into account in the total mass of the sources of the elements Si and Al.

Step i) may comprise a step of maturation of the reaction mixture at a temperature between 20 and 100° C., with or without stirring, for a period of between 30 minutes and 48 hours.

The hydrothermal treatment of step ii) is advantageously carried out under reflux at a temperature between 75 and 95° C., preferably between 85° C. and 95° C., limits included, for a period of between 40 and 100 hours, preferably between 48 and 80 hours, preferably under atmospheric pressure.

1) at least one ion exchange comprising bringing said solid obtained at the end of the previous step into contact with a solution comprising at least one species capable of releasing a transition metal, in solution in reactive form, with stirring at ambient temperature for a period of between 1 hour and 2 days.

iv) heat treatment by drying the solid obtained at the end of the previous step at a temperature between 20 and 150° C., followed by at least one calcination under a stream of air at a temperature between 400 and 700° C.

Steps iii) and iv) may be reversed, and optionally repeated.

More particularly, the process according to the present invention comprises a step i) of mixing, in an aqueous medium, of at least one source of silicon (Si) in SiO₂ oxide form, at least one source of aluminum (Al) in Al₂O₃ oxide form, a nitrogenous organic compound R, R being 1,6-bis(methylpiperidinium)hexane dihydroxide, and at least one source of at least one alkali metal chosen from lithium, potassium or sodium, and the mixture of at least two of these metals, the reaction mixture having the following molar composition:

SiO₂/Al₂O₃ between 4 and 60, preferably between 8 and 40,

H₂O/SiO₂ between 5 and 60, preferably between 10 and 40

R/SiO₂ between 0.05 and 0.50, preferably between 0.10 and 0.30

M₂O/SiO₂ between 0.10 and 0.30, preferably between 0.15 and 0.25, until a homogeneous precursor gel is obtained;

then a step ii) of hydrothermal treatment of said precursor gel obtained at the end of step i) at a temperature between 75° C. and 95° C., preferably of between 85° C. and 95° C., limits included, for a period of between 40 and 100 hours, preferably of between 48 and 80 hours, until said AFX-structure zeolite of high purity forms.

In the molar composition of the reaction mixture above and throughout the description:

SiO₂ denotes the molar amount of silicon expressed in oxide form, and Al₂O₃ denotes the molar amount of aluminum expressed in oxide form,

H₂O the molar amount of water present in the reaction mixture,

R the molar amount of said nitrogenous organic compound,

M₂O the molar amount expressed in oxide form of M₂O by the source of alkali metal.

One advantage of the present invention is therefore that it provides a novel preparation process for forming a pure AFX-structure zeolite at the end of step ii).

Another advantage of the present invention is that it allows the preparation of a precursor gel of an AFX-structure zeolite by virtue of the combination of an organic or specific structuring species comprising two quaternary ammonium functions, 1,6-bis(methylpiperidinium)hexane dihydroxide and of very specific operating conditions, notably a hydrothermal treatment at controlled temperature.

Step ii) comprises a hydrothermal treatment of said precursor gel obtained at the end of step i) which is carried out at a temperature between 75° C. and 95° C., preferably between 85° C. and 95° C., limits included, for a period of between 40 and 100 hours, preferably between 48 and 80 hours, until said AFX-structure zeolite crystallizes. It is thus possible to carry out this step at atmospheric pressure, notably in a reactor open to the atmosphere.

In accordance with the invention, at least one source of at least one oxide SiO₂ is incorporated into the mixture for carrying out step (i) of the preparation process. The source of silicon may be any one of said sources commonly used for zeolite synthesis, for example powdered silica, silicic acid, colloidal silica, dissolved silica or tetraethoxysilane (TEOS). Among the powdered silicas, use may be made of precipitated silicas, notably those obtained by precipitation from a solution of alkali metal silicate, fumed silicas, for example Aerosil, and silica gels. Colloidal silicas having various particle sizes, for example a mean equivalent diameter of between 10 and 15 nm or between 40 and 50 nm, may be used, such as those sold under registered trademarks such as Ludox. Preferably, the source of silicon is Ludox HS-40.

In accordance with the invention, at least one source of Al₂O₃ is incorporated into the mixture for carrying out said step (i). The source of aluminum is preferably aluminum hydroxide or an aluminum salt, for example chloride, nitrate or sulfate, a sodium aluminate, an aluminum alkoxide, or alumina itself, preferably in hydrated or hydratable form, for instance colloidal alumina, pseudoboehmite, gamma-alumina or alpha or beta alumina trihydrate. Use may also be made of mixtures of the sources mentioned above.

In accordance with the invention, R is a nitrogen-comprising organic compound, 1,6-bis(methylpiperidinium)hexane dihydroxide, said compound being incorporated into the reaction mixture for the implementation of step (i), as organic structuring agent. The anion associated with the quaternary ammonium cations present in the organic structuring species for the synthesis of an AFX-structure zeolite according to the invention is the hydroxide anion.

In accordance with the invention, at least one source of at least one alkali metal is used in the reaction mixture of step i), M preferably being chosen from lithium, potassium, sodium and the mixture of at least two of these metals. Very preferably, M is sodium.

The source of at least one alkali metal and/or alkaline-earth metal M is preferably sodium hydroxide.

It may be advantageous to add seeds of an AFX-structure zeolite to the reaction mixture during said step i) of the process of the invention so as to reduce the time needed for the formation of the crystals of an AFX-structure zeolite and/or the total crystallization time. Said seed crystals also promote the formation of said AFX-structure zeolite to the detriment of impurities. Such seeds comprise crystalline solids, notably crystals of an AFX-structure zeolite. The seed crystals are generally added in a proportion of between 0.05% and 10% of the total mass of the sources of said element(s) Si and Al in anhydrous form used in the reaction mixture, said seed crystals not being taken into account in the total mass of the sources of the elements Si and Al. Said seeds are not taken into account either for determining the composition of the reaction mixture and/or of the gel, defined above, i.e. in the determination of the various molar ratios of the composition of the reaction mixture.

The mixing step i) is performed until a homogeneous mixture is obtained, preferably for a period of greater than or equal to 10 minutes, preferably with stirring by any system known to those skilled in the art, at a low or high shear rate.

At the end of step i), a homogeneous precursor gel is obtained.

It may be advantageous to perform a maturation of the reaction mixture during said step i) of the process of the invention, before the hydrothermal crystallization, so as to control the size of the crystals of an AFX-structure zeolite. Said maturation also promotes the formation of said AFX-structure zeolite to the detriment of impurities.

Maturation of the reaction mixture during said step i) of the process of the invention may be performed at ambient temperature or at a temperature between 20 and 60° C. with or without stirring, for a period advantageously of between 30 minutes and 48 hours.

In accordance with step ii) of the process according to the invention, the precursor gel obtained at the end of step i) is subjected to a hydrothermal treatment, carried out at a temperature between 75 and 95° C., preferentially carried out at a temperature between 85 and 95° C., limits included for a period of between 40 and 100 hours, until said AFX-structure zeolite is formed.

The time required to obtain crystallization ranges between 40 and 100 hours, preferably between 48 and 80 hours.

The reaction is generally carried out with or without stirring, preferably with stirring. The stirring system that may be used is any system known to those skilled in the art, for example inclined paddles with counter-blades, stirring turbomixers or endless screws.

At the end of the reaction, after performing said step ii) of the preparation process according to the invention, the solid phase formed from an AFX-structure zeolite is preferably filtered off, washed and then dried. The drying is generally performed at a temperature between 20° C. and 150° C., preferably between 60° C. and 100° C., for a period of between 5 and 24 hours.

It is also advantageous to obtain the protonated form of the AFX-structure zeolite obtained via the process according to the invention. Said protonated form may be obtained by performing an ion exchange with an acid, in particular a strong mineral acid such as hydrochloric, sulfuric or nitric acid, or with a compound such as ammonium chloride, sulfate or nitrate. The ion exchange may be performed by placing said AFX-structure zeolite in suspension one or more times with the ion-exchange solution. Said zeolite may be calcined before or after the ion exchange or between two ion-exchange steps. The zeolite is preferably calcined before the ion exchange, so as to remove any organic substance included in the porosity of the zeolite, since the ion exchange is thereby facilitated.

The process for preparing the catalyst according to the invention also comprises:

iii) at least one ion exchange comprising bringing said solid obtained at the end of the previous step into contact with a solution comprising at least one species capable of releasing a transition metal, in solution in reactive form, with stirring at ambient temperature for a period of between 1 hour and 2 days;

According to the invention, the transition metal or metals included in the catalyst is/are selected from the elements of the group made up of the elements of groups 3 to 12 of the periodic table of the elements, including the lanthanides. In particular, the transition metal or metals included in the catalyst is/are selected from the group formed by the following elements: Ti, V, Mn, Mo, Fe, Co, Cu, Cr, Zn, Nb, Ce, Zr, Rh, Pd, Pt, Au, W, Ag.

Preferably, the catalyst according to the invention comprises copper, alone or in combination with at least one other transition metal chosen from the group of elements listed above; in particular Fe, Nb, Ce, Mn.

The total content of the transition metals is advantageously between 0.5% and 6% by mass, preferably between 0.5% and 5% by mass, and even more preferably between 1% and 4% by mass; relative to the total mass of the final catalyst in its anhydrous form.

In the case of catalysts containing only copper as transition metal; the content is advantageously between 0.5% and 6%, preferably between 0.5% and 5%, and more preferably between 1% and 4% by weight, relative to the total mass of the anhydrous final catalyst.

In the case of catalysts comprising copper and another element such as, preferably, Fe, Nb, Ce, Mn, the content of copper in the catalyst is between 0.05% and 2% by mass, preferably between 0.5% and 2% by mass, while the content of the other transition metal is preferably between 1% and 4% by mass, the contents of transition metals being given as percentages by mass relative to the total mass of the final dry catalyst.

In the case of catalysts containing only iron as the transition metal, the content is between 0.5 and 4% and even more preferably between 1.5 and 3.5% relative to the total mass of the final anhydrous catalyst.

In the case of catalysts comprising iron and another element such as, preferably, Cu, Nb, Ce, Mn, the content of iron in the catalyst is between 0.05% and 2% by mass, preferably between 0.5% and 2% by mass, while the content of the other transition metal is preferably between 1% and 4% by mass, the contents of transition metals being given as percentages by mass relative to the total mass of the final dry catalyst.

According to the invention, “species capable of releasing a transition metal” is understood to mean a species which is capable of dissociating in an aqueous medium, such as for example sulfates, nitrates, chlorides, oxalates, or organometallic complexes of a transition metal, or mixtures thereof. Preferably, the species capable of releasing a transition metal is a sulfate or a nitrate of said transition metal.

According to the invention, the solution with which the crystallized solid or dried and calcined crystallized solid is brought into contact comprises at least one species capable of releasing a transition metal, preferably a single species capable of releasing a transition metal, preferably iron or copper, preferentially copper.

The catalyst according to the invention may also comprise other elements, such as for example alkali and/or alkaline-earth metals, for example sodium, originating notably from the synthesis, in particular of the compounds of the reaction medium of step i) of the process for preparing said catalyst.

The preparation process also comprises a step iv) of heat treatment by drying the solid obtained at the end of the previous step at a temperature between 20 and 150° C., followed by at least one calcination under a stream of air at a temperature between 450 and 700° C., it being possible for steps iii) and iv) to be advantageously reversed, and optionally repeated if necessary.

Said step iv) of heat treatment comprises drying the solid at a temperature between 20 and 150° C., preferably between 60 and 100° C., advantageously for a period of between 2 and 24 hours, followed by at least one calcination under air, which is optionally dry, at a temperature advantageously between 450 and 700° C., preferably between 500 and 600° C., for a period of between 2 and 20 hours, preferably of between 5 and 10 hours, more preferably of between 6 and 9 hours, the flow rate of optionally dry air being preferably between 0.5 and 1.5 L/h/g of solid to be treated, more preferably between 0.7 and 1.2 L/h/g of solid to be treated. The calcination may be preceded by a gradual temperature increase.

The catalyst obtained at the end of the heat treatment step iv) is devoid of any organic species, in particular devoid of the organic structuring agent R.

The present invention also relates to the catalyst comprising an AFX-structure zeolite and at least one transition metal capable of being obtained or directly obtained by the process described above.

Finally, the invention relates to the use of a catalyst according to the invention for the selective catalytic reduction of NOx in the presence of a reducing agent.

At the end of said step ii) of preparation of the AFX zeolite, X-ray diffraction makes it possible to confirm that the solid obtained by the process according to the invention is indeed an AFX-structure zeolite. The purity obtained is advantageously greater than 90%, preferably greater than 95% and very preferably greater than 99.8% by weight.

This diffraction pattern is obtained by radiocrystallographic analysis by means of a diffractometer using the conventional powder method with the Kai radiation of copper (λ=1.5406 Å). On the basis of the position of the diffraction peaks represented by the angle 2θ, the lattice constant distances dₕₖₗ characteristic of the sample are calculated using the Bragg relationship. The measurement error Δ(dₕₖₗ) over dₕₖₗ is calculated by means of Bragg's law as a function of the absolute error Δ(2θ) assigned to the measurement of 2θ. An absolute error Δ(2θ) equal to ±0.02° is commonly accepted. The relative intensity Iᵣₑₗ assigned to each value of dₕₖₗ is measured according to the height of the corresponding diffraction peak. The X-ray diffraction pattern of the AFX-structure crystalline solid according to the invention includes at least the lines at the dₕₖₗ values given in table 1. In the column of the dₕₖₗ values, the mean values of the lattice spacings have been shown in angströms (Δ). Each of these values must be assigned the measurement error Δ(dₕₖₗ) of between ±0.6 Å and ±0.01 Å.

Table 1: Mean values of dₕₖₗ and relative intensities measured on an X-ray diffraction pattern of the AFX-structure crystalline solid.

TABLE 1

| 2 theta (°) | dₕₖₗ (Å) | Iᵣₑₗ |
|---|---|---|
| 7.47 | 11.83 | mw |
| 8.56 | 10.32 | w |
| 8.67 | 10.19 | mw |
| 11.59 | 7.63 | w |
| 12.96 | 6.82 | mw |
| 14.99 | 5.91 | vw |
| 15.60 | 5.67 | w |
| 17.42 | 5.09 | mw |
| 17.77 | 4.99 | mw |
| 19.86 | 4.47 | w |
| 20.32 | 4.37 | m |
| 21.74 | 4.08 | VS |
| 22.52 | 3.95 | w |
| 26.06 | 3.42 | m |
| 27.69 | 3.22 | mw |
| 27.76 | 3.21 | w |
| 27.86 | 3.20 | mw |
| 29.74 | 3.00 | vw |
| 30.22 | 2.95 | mw |
| 30.49 | 2.93 | mw |
| 31.48 | 2.84 | mw |
| 33.57 | 2.67 | w |
| 34.68 | 2.58 | w |

X-ray fluorescence spectrometry (XFS) is a chemical analysis technique using a physical property of matter, X-ray fluorescence. It enables the analysis of the majority of the chemical elements starting from beryllium (Be) in concentration ranges ranging from a few ppm to 100%, with precise and reproducible results. X-rays are used to excite the atoms in a sample, which makes them emit X-rays having an energy characteristic of each element present. The intensity and the energy of these X-rays are then measured to determine the concentration of the elements in the material.

Use of the Catalyst According to the Invention

The invention also relates to the use of the catalyst according to the invention, directly prepared or capable of being prepared by the process described above, for the selective reduction of NOₓ by a reducing agent such as NH₃ or H₂, advantageously formed by deposition in the form of a coating (or “washcoat”) on a honeycomb structure, primarily for mobile applications, or on a plate structure, as found in particular for stationary applications.

The honeycomb structure is formed of parallel channels which are open at both ends (“flow-through channels”) or comprises porous filtering walls, in which case the adjacent parallel channels are alternately blocked at either side of the channels to force the gas flow to pass through the wall (“wall-flow monolith”). Said honeycomb structure thus coated constitutes a catalytic block. Said structure may be composed of cordierite, silicon carbide (SiC), aluminum titanate (AlTi), alpha-alumina, mullite, or any other material having a porosity of between 30% and 70%. Said structure may be formed in metal sheet, in stainless steel containing chromium and aluminum, FeCrAl steel.

The amount of catalyst according to the invention deposited on said structure is between 50 and 180 g/L for the filtering structures and between 80 and 200 g/L for the structures with open channels.

The actual coating (“washcoat”) comprises the catalyst according to the invention, advantageously in combination with a binder such as cerin, zirconium oxide, alumina, non-zeolitic silica-alumina, titanium oxide, a mixed oxide of ceria-zirconia type, a tungsten oxide, a spinel. Said coating is advantageously applied to said structure by a deposition method known as washcoating, which involves soaking the monolith in a suspension (or slurry) of powdered catalyst according to the invention in a solvent, preferably water, and optionally binders, metal oxides, stabilizers or other promoters. This soaking step may be repeated until the desired amount of coating is obtained. In certain cases the slurry may also be sprayed inside the monolith. Once the coating has been deposited, the monolith is calcined at a temperature of 300 to 600° C. for 1 to 10 hours.

Said structure may be coated with one or more coatings. The coating comprising the catalyst according to the invention is advantageously combined with, i.e. covers or is covered by, another coating having capacities for adsorbing pollutants, in particular NOx, for reducing pollutants, in particular NOx, or promoting the oxidation of pollutants, in particular that of ammonia.

Another possibility is for the catalyst to be in the form of an extrudate. In this case, the structure obtained may contain up to 100% of catalyst according to the invention.

Said structure coated with the catalyst according to the invention is advantageously integrated into an exhaust line of an internal combustion engine operating mainly in lean-mixture mode, that is to say with excess air relative to the stoichiometry of the combustion reaction, as is the case with diesel engines for example. Under these engine operating conditions, the exhaust gases contain notably the following pollutants: soot, unburned hydrocarbons (HCs), carbon monoxide (CO), nitrogen oxides (NOx). Upstream of said structure coated with the catalyst according to the invention may be placed an oxidation catalyst, the function of which is to oxidize the HCs and CO, and a filter for removing soot from the exhaust gases, the function of said coated structure being to remove the NOx, its operating range being between 100 and 900° C. and preferably between 200° C. and 500° C.

### Advantages of the Invention

The catalyst according to the invention, based on an AFX-structure zeolite and at least one transition metal, in particular copper, has improved properties and ease of preparation compared with the prior art catalysts. In particular, the use of the catalyst according to the invention makes it possible to obtain lower light-off temperatures for the NOx conversion reaction and an improved NOx conversion across the entire operating temperature range (150° C.−600° C.), while maintaining a good selectivity for N₂O. It also has a better resistance to hydrothermal aging, ensuring high performance even after such aging.

### EXAMPLES

The invention is illustrated by the examples that follow, which are not in any way limiting in nature.

Example 1: preparation of 1.6-bis(methylpiperidinium)hexane dihydroxide (structuring agent R).

50 g of 1,6-dibromohexane (0.20 mol, 99%, Alfa Aesar) are placed in a 1 L round-bottom flask containing 50 g of N-methylpiperidine (0.51 mol, 99%, Alfa Aesar) and 200 mL of ethanol. The reaction medium is stirred and refluxed for 5 hours. The mixture is then cooled to ambient temperature and then filtered. The mixture is poured into 300 mL of cold diethyl ether and the precipitate formed is filtered off and washed with 100 mL of diethyl ether. The solid obtained is recrystallized in an ethanol/ether mixture. The solid obtained is dried under vacuum for 12 hours. 71 g of a white solid are obtained (i.e. a yield of 80%).

The product has the expected ¹H NMR spectrum. ¹H NMR (D₂O, ppm/TMS): 1.27 (4H, m); 1.48 (4H, m); 1.61 (4H, m); 1.70 (8H, m); 2.85 (6H, s); 3.16 (12H, m).

18.9 g of Ag₂O (0.08 mol, 99%, Aldrich) are placed in a 250 ml Teflon beaker containing 30 g of the structuring agent 1,6-bis(methylpiperidinium)hexane dibromide (0.07 mol) prepared and 100 ml of deionized water. The reaction medium is stirred for 12 hours in the absence of light. The mixture is then filtered. The filtrate obtained is composed of an aqueous solution of 1,6-bis(methylpiperidinium)hexane dihydroxide. Assaying of this species is performed by proton NMR using formic acid as standard.

Example 2: preparation of a catalyst containing an AFX-structure zeolite according to the invention.

Preparation of the AFX zeolite

49.83 g of an aqueous solution of

1,6-bis(methylpiperidinium)hexane dihydroxide (18.36% by weight) prepared according to example 1 were mixed with 0.466 g of deionized water. 2.1 g of sodium hydroxide (solid, 98% by weight purity, Aldrich) are added to the above mixture, and the preparation obtained is kept stirring for 10 minutes. Subsequently, 1.66 g of sodium aluminate (53.17% Al₂O₃ by weight, Strem Chemicals) are incorporated and the synthesis gel is kept stirring for 15 minutes. Lastly, 25.96 g of colloidal silica (Ludox HS40, 40% SiO₂ by weight, Aldrich) and 1.038 g of seeds of an AFX-structure zeolite obtained by any method known by those skilled in the art were incorporated into the synthesis mixture. The molar composition of the mixture, without taking into account the seeds, is as follows: 100 SiO₂: 5 Al₂O₃: 16.7 R: 22.36 Na₂O: 1836 H₂O, i.e. an SiO₂/Al₂O₃ ratio of 10. The precursor gel is then transferred, after homogenization, into a reactor equipped with a reflux condenser. The reactor is then heated with an increase in temperature of 5° C./min up to 95° C. for 40 hours with stirring at 200 rpm using a system with 4 inclined paddles. The crystallized product obtained is filtered off, washed with deionized water and then dried overnight at 100° C. The loss on ignition of the product obtained after drying is 15%. The solid is then introduced into a muffle furnace where a calcination step is performed: the calcination cycle comprises an increase in temperature of 1.5° C./min up to 200° C., a steady stage at 200° C. maintained for 2 hours, an increase in temperature of 1° C./min up to 550° C., followed by a steady stage at 550° C. maintained for 8 hours, then a return to ambient temperature.

The calcined solid product was analyzed by X-ray diffraction and identified as consisting of an AFX-structure zeolite with a purity of greater than 99.8%. The diffraction pattern produced for the calcined AFX-structure solid is given in FIG. 2. The product has an SiO₂/Al₂O₃ molar ratio of 12 as determined by X-ray fluorescence.

The calcined AFX zeolite is then brought into contact with a 3 M NH₄NO₃ solution for 1 hour with stirring at 80° C. The ratio between the volume of NH₄NO₃ solution and the mass of solid is 10. The solid obtained is filtered off and washed and the exchange procedure is repeated twice more under the same conditions. The final solid is separated, washed and dried for 12 hours at 100° C. The AFX zeolite in ammoniacal form is treated under a stream of air at 550° C. for 8 hours with a temperature increase gradient of 1° C./min. The product obtained is an AFX zeolite in protonated form.

Cu Ion Exchange

The calcined AFX zeolite in protonated form is brought into contact with a solution of [Cu(NH₃)₄](NO₃)₂ for 1 day with stirring at ambient temperature. The final solid is separated off, washed and dried for 12 hours at a temperature of 100° C.

The exchanged Cu-AFX solid obtained after the contacting with the [Cu(NH₃)₄](NO₃)₂ solution is calcined under a stream of air at 550° C. for 8 hours.

The solid obtained has an SiO₂/Al₂O₃ molar ratio of 12 and a percentage by mass of Cu of 3% as determined by X-ray fluorescence.

The catalyst obtained is denoted CuAFX.

Example 3: NOx conversion under standard SCR conditions

A catalytic test of nitrogen oxide (NOx) reduction by ammonia (NH₃) in the presence of oxygen (O₂) under standard SCR conditions is carried out at different operating temperatures for the catalyst obtained according to example 2 (CuAFX, according to the invention). For testing each sample, 200 mg of catalyst in powder form are placed in a quartz reactor. 145 L/h of a feedstock representative of a mixture of exhaust gas from a diesel engine are fed into the reactor.

This feedstock has the following molar composition: 400 ppm NO, 400 ppm NH₃, 8.5% O₂, 9% CO₂, 10% H₂O, remainder N₂.

An FTIR analyzer is used to measure the concentration of the species NO, NO₂, NH₃, N₂O, CO, CO₂, H₂O, O₂ at the reactor outlet. NOx conversions are calculated as follows:

Conversion=(NOx inlet−NOx outlet)/NOx inlet

The light-off temperatures for the catalysts are given below for standard SCR conditions:

TABLE 2

| | T50 | T80 | T90 | T100 |
|---|---|---|---|---|
| CuAFX | 180° C. | 212° C. | 230° C. | 320° C. |

T50 corresponds to the temperature at which 50% of the NOx in the gas mixture are converted by the catalyst. T80 corresponds to the temperature at which 80% of the NOx in the gas mixture are converted by the catalyst. T90 corresponds to the temperature at which 90% of the NOx in the gas mixture are converted by the catalyst. T100 corresponds to the temperature at which 100% of the NOx in the gas mixture are converted by the catalyst.

Example 5: NOx conversion under fast SCR conditions:

A catalytic test for the reduction of nitrogen oxides (NOx) by ammonia (NH₃) in the presence of oxygen (O₂) under fast SCR conditions is carried out at different operating temperatures for the catalyst synthesized according to the invention (example 2)

200 mg of catalyst in powder form are placed in a quartz reactor. 218 l/h of a feedstock representative of a mixture of exhaust gas from a diesel engine are fed into the reactor. This feedstock has the following molar composition: 200 ppm NO, 200 ppm NO₂, 400 ppm NH₃, 8.5% O₂, 9% CO₂, 10% H₂O, remainder N₂ for fast SCR conditions.

An FTIR analyzer is used to measure the concentration of the species NO, NO₂, NH₃, N₂O, CO, CO₂, H₂O, O₂ at the reactor outlet. NOx conversions are calculated as follows:

Conversion=(NOx inlet−NOx outlet)/NOx inlet

The light-off temperatures for the catalysts are given below for fast SCR conditions:

TABLE 3

| | T50 | T80 | T90 | T100 |
|---|---|---|---|---|
| CuAFX | 144° C. | 178° C. | 198° C. | 255° C. |

T50 corresponds to the temperature at which 50% of the NOx in the gas mixture are converted by the catalyst. T80 corresponds to the temperature at which 80% of the NOx in the gas mixture are converted by the catalyst. T90 corresponds to the temperature at which 90% of the NOx in the gas mixture are converted by the catalyst. T100 corresponds to the temperature at which 100% of the NOx in the gas mixture are converted by the catalyst.

The nitrous oxide (N₂O) emissions, in the case of the CuAFX catalyst according to the invention, remain low over the entire temperature range tested (<15 ppm between 150 and 550° C.).

1. A process for preparing a catalyst based on an AFX zeolite exchanged with at least one transition metal, comprising at least the following steps:
i) mixing, in an aqueous medium, of at least one source of silicon (Si) in SiO₂ oxide form, at least one source of aluminum (Al) in Al₂O₃ oxide form, a nitrogenous organic compound R, R being 1,6-bis(methylpiperidinium)hexane dihydroxide, and at least one source of at least one alkali metal M chosen from lithium, potassium or sodium, and the mixture of at least two of these metals, the reaction mixture having the following molar composition:
SiO₂/Al₂O₃ between 4 and 60, preferably between 8 and 40,
H₂O/SiO₂ between 5 and 60, preferably between 10 and 40,
R/SiO₂ between 0.05 and 0.50, preferably between 0.10 and 0.30,
M₂O/SiO₂ between 0.10 and 0.30, preferably between 0.15 and 0.25,
until a homogeneous precursor gel is obtained;
ii) hydrothermal treatment of the precursor gel obtained at the end of step i) at a temperature between 75° C. and 95° C., limits included, for a period of between 40 and 100 hours, limits included, to obtain a solid crystalline phase, termed “solid”;
iii) at least one ion exchange comprising bringing the solid obtained at the end of the previous step into contact with a solution comprising at least one species capable of releasing a transition metal, in solution in reactive form, with stirring at ambient temperature for a period of between 1 hour and 2 days;
iv) heat treatment by drying the solid obtained at the end of the previous step at a temperature between 20 and 150° C., followed by at least one calcination under a stream of air at a temperature between 400 and 700° C.

2. The process as claimed in claim 1, wherein steps iii) and iv) are reversed, and optionally repeated.

3. The process as claimed in claim 1, wherein the precursor gel obtained at the end of step i) has a molar ratio of the total amount, expressed as oxides, of tetravalent elements to the total amount, expressed as oxides, of trivalent elements of between 4.00 and 60.00, preferably between 8.00 and 40.00, limits included.

4. The process as claimed in claim 1, wherein seed crystals of an AFX-structure zeolite are added to the reaction mixture of step i), preferably in an amount of between 0.05 and 10% of the total mass of the sources of alumina and silica in anhydrous form used in the reaction mixture, the seed crystals not being taken into account in the total mass of the sources of alumina and silica.

5. The process as claimed in claim 1, wherein step i) comprises a step of maturing the reaction mixture at a temperature between 20 and 60° C., with or without stirring, for a period of between 30 minutes and 48 hours.

6. The process as claimed in claim 1, wherein the hydrothermal treatment of step ii) is carried out at atmospheric pressure, preferably at a temperature between 85 and 95° C., limits included, for a period preferably of between 40 and 80 hours, very preferably between 48 and 80 hours, limits included.

7. The process as claimed in claim 1, wherein the ion-exchange step iii) is performed by bringing the solid into contact with a solution comprising just one species capable of releasing a transition metal or by bringing the solid into contact successively with various solutions, each comprising at least one, preferably just one, species capable of releasing a transition metal, the transition metals of the various solutions preferably being different from one another.

8. The process as claimed in claim 7, wherein the at least one transition metal released in the exchange solution of step iii) is selected from the group formed by the following elements: Ti, V, Mn, Mo, Fe, Co, Cu, Cr, Zn, Nb, Ce, Zr, Rh, Pd, Pt, Au, W, Ag, preferably from the group made up of the following elements: Fe, Cu, Nb, Ce or Mn, more preferably from Fe or Cu, and even more preferably the transition metal is Cu.

9. The process as claimed claim 1, wherein the content of transition metal(s) introduced by the ion-exchange step iii) is between 0.5 and 6% by mass, preferably between 0.5 and 5% by mass, more preferably between 1 and 4% by mass, relative to the total mass of the final anhydrous catalyst.

10. The process as claimed in claim 1, wherein the heat treatment step iv) involves drying the solid at a temperature between 20 and 150° C., preferably between 60 and 100° C., for a period of between 2 and 24 hours, followed by at least one calcination in air, optionally dry air, at a temperature between 450 and 700° C., preferably between 500 and 600° C., for a period of between 2 and 20 hours, preferably between 5 and 10 hours, even more preferably between 6 and 9 hours, the flow rate of optionally dry air being preferably between 0.5 and 1.5 L/h/g of solid to be treated, even more preferably between 0.7 and 1.2 L/h/g of solid to be treated.

11. A catalyst based on an AFX zeolite and at least one transition metal obtained by the process as claimed in claim 1.

12. The catalyst as claimed in claim 11, wherein the transition metal or metals is/are selected from the group made up of the following elements: Ti, V, Mn, Mo, Fe, Co, Cu, Cr, Zn, Nb, Ce, Zr, Rh, Pd, Pt, Au, W, Ag, preferably from the group made up of the following elements: Fe, Cu, Nb, Ce or Mn, more preferably from Fe or Cu, and even more preferably the transition metal is Cu.

13. The catalyst as claimed in claim 11, wherein the total content of transition metals is between 0.5% and 6% by mass, preferably between 0.5% and 5% by mass, more preferably between 1% and 4% by mass, relative to the total mass of the final anhydrous catalyst.

14. The catalyst as claimed in claim 13 comprising copper, alone, at a content of between 0.5% and 6% by weight, preferably between 0.5% and 5% by weight, very preferably between 1% and 4% by weight relative to the total mass of the final anhydrous catalyst.

15. The catalyst as claimed in claim 13, comprising copper in combination with at least one other transition metal chosen from the group formed by Fe, Nb, Ce, Mn, the copper content in the catalyst being between 0.05% and 2% by mass, preferably between 0.5% and 2% by mass, the content of the at least one other transition metal being between 1% and 4% by mass, relative to the total mass of the final anhydrous catalyst.

16. The catalyst as claimed in claim 13, comprising iron in combination with another metal chosen from the group formed by Cu, Nb, Ce, Mn, the iron content being between 0.05% and 2% by mass, preferably between 0.5% and 2% by mass, the content of the other transition metal being between 1% and 4% by mass, relative to the total mass of the final anhydrous catalyst.

17. The use of the catalyst as claimed in claim 11, for the selective reduction of NOₓ by a reducing agent such as NH₃ or H₂.

18. The use as claimed in claim 17, for which the catalyst is formed by deposition in the form of a coating on a honeycomb structure or a plate structure.

19. The use as claimed in claim 18, for which the honeycomb structure is formed by parallel channels open at both ends or comprises porous filtering walls for which the adjacent parallel channels are alternately blocked at either side of the channels.

20. The use as claimed in claim 19, for which the amount of catalyst that is deposited on the structure is between 50 and 180 g/L for filtering structures and between 80 and 200 g/L for structures with open channels.

21. The use as claimed in claim 17, for which the catalyst is combined with a binder such as ceria, zirconium oxide, alumina, non-zeolitic silica-alumina, titanium oxide, a ceria-zirconia mixed oxide, a tungsten oxide and/or a spinel in order to be formed by deposition in the form of a coating.

22. The use as claimed in claim 18, for which the coating is combined with another coating having the capacity to adsorb pollutants, in particular NOx, to reduce pollutants, in particular NOx, or to promote the oxidation of pollutants.

23. The use as claimed in claim 17, for the catalyst is in the form of an extrudate containing up to 100% of the catalyst.

24. The use as claimed in claim 17, for which the structure coated with the catalyst or obtained by extrusion of the catalyst is integrated into an exhaust line of an internal combustion engine.
